(19) United States
(12) Patent Application Publication
(10) Pub. No.: US 2006/0023368 A1
(43) Pub. Date: Feb. 2, 2006

(54) Magnetic recording apparatus

(75) Inventors: Akira Kikitsu, Yokohama-shi (JP); Makoto Asakura, Tokyo (JP); Masatoshi Sakurai, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/191,271

(22) Filed: Jul. 28, 2005

(30) Foreign Application Priority Data
Jul. 30, 2004 (JP) 2004-224924

(51) Int. Cl. G11B 5/33; G11B 5/127

(52) U.S. Cl. 360/323

(57) ABSTRACT

A magnetic recording apparatus includes a magnetic recording media, a spindle motor which rotates the magnetic recording media, a flying head slider including a read head using a giant magnetoresistive element, an actuator which moves the head slider over the magnetic recording media, a chassis which houses the above members and a discharge mechanism which passes metal portions and dielectric portions alternately with facing to the read head within a distance of 50 nm or less.

### CROSS-REFERENCE TO RELATED APPLICATIONS

This application is based upon and claims the benefit of priority from prior Japanese Patent Application No. 2004-224924, filed Jul. 30, 2004, the entire contents of which are incorporated herein by reference.

### BACKGROUND OF THE INVENTION

1. Field of the Invention

The present invention relates to a magnetic recording apparatus having a discharge function that prevents electrostatic discharge damage of a read head using a giant magnetoresistive element.

2. Description of the Related Art

In order to achieve a high-density magnetic recording apparatus, it is essential to have a read element of a high sensitivity which can detect sufficiently high-level signals from a minute recorded domain. Conventionally, there has been proposed a magnetic recording apparatus comprising: a thin-film magnetic head including a single-pole head, and a magentoresistive element; and a magnetic recording media comprising servo mark zones formed along the radial direction made of protruded portions and recessed portions, data zones formed along the circumferential direction separated by the servo mark zone, and a high-permeability layer and a perpendicular recording layer formed on the servo mark zones and the data zones, wherein the perpendicular recording layer is magnetized in opposite directions on the protruded portions and the recessed portions, respectively, in the servo mark zones (See Jpn. Pat. Appln. KOKAI Publication No. 7-121804). However, the magnetoresistive element in this document is not a so-called giant magnetoresistive element (GMR element), and thus it is hard to address further high-density recording.

Therefore, in order to achieve further high-density recording, it is necessary to use a GMR element of higher read sensitivity. The GMR element includes a spin valve film in which a pinned layer (the direction of magnetization is pinned), a spacer layer, and a free layer (magnetization of which freely rotates in accordance with a magnetic field) are stacked. The GMR element can be further categorized into a current-in-plane GMR (CIP-GMR), a current-perpendicular-to-plane GMR (CPP-GMR), a tunneling magnetoresistive (TMR) and a current-confined-path GMR (CCP-GMR). In the CIP-GMR, the spacer layer is made of a metal layer wherein a sense current is passed through in the in-plane direction. In the CPP-GMR, the spacer layer is made of a metal layer wherein a sense current is passed through in the direction perpendicular to the plane. In the TMR, the spacer layer is made of a dielectric layer wherein a sense current is passed through in the direction perpendicular to the plane. In the CCP-GMR, the spacer layer is made of a dielectric layer and small metal paths wherein a sense current is passed through the metal paths in the direction perpendicular to the plane. The sensitivity of the element becomes higher in the order mentioned above, and it is known that the element with higher sensitivity can achieve a higher recording density.

However, the GMR elements entail such a drawback that they are susceptible to electrostatic discharge damage. The CIP-GMR and CPP-GMR detect resistance change of the sense current passing through the metal spacer layer having a thickness of several nanometers. Therefore, if static electric charge is created for some reason and it is discharged at the metal spacer layer, the element is damaged and loses the read-out function. In the TMR and CCP-GMR, if the dielectric layer constituting the spacer layer of a thickness of about 1 nm is damaged by electrostatic discharge, they lose the function as a read element.

### BRIEF SUMMARY OF THE INVENTION

A magnetic recording apparatus according to an aspect of the present invention comprises: a magnetic recording media; a spindle motor which rotates the magnetic recording media; a flying head slider including a read head using a giant magnetoresistive element; an actuator which moves the head slider over the magnetic recording media; a chassis which houses the above members; and a discharge mechanism which passes metal portions and dielectric portions alternately with facing to the read head within a distance of 50 nm or less.

### BRIEF DESCRIPTION OF THE SEVERAL VIEWS OF THE DRAWING

FIG. 1 is a perspective view showing a magnetic recording apparatus according to an embodiment of the present invention;

FIG. 2 is a diagram schematically showing a placement of a magnetic disk and a head slider;

FIG. 3 is a plan view showing the air-bearing surface of the head slider;

FIG. 4 is a cross-sectional view showing a structure of a magnetic head;

FIG. 5 is a diagram schematically showing a placement of a discharge mechanism and the head slider;

FIG. 6 is a diagram indicating results of accelerated tests for electrostatic discharge damage of GMR elements in magnetic recording apparatuses manufactured using magnetic disks of various sizes;

FIG. 7 is a perspective view showing an example of a magnetic disk provided with a discharge mechanism;

FIG. 8 is a perspective view showing another example of a magnetic disk provided with a discharge mechanism;

FIG. 9 is a cross-sectional view showing an example of a magnetic disk provided with a discharge mechanism;

FIG. 10 is a cross-sectional view showing another example of a magnetic disk provided with a discharge mechanism;

FIG. 11 is a cross-sectional view showing still another example of a magnetic disk provided with a discharge mechanism;

FIG. 12 is a cross-sectional view showing still another example of a magnetic disk provided with a discharge mechanism;

FIG. 13 is a perspective view showing a chassis used for the magnetic recording apparatus according to the embodiment of the present invention; and

FIG. 14 is a diagram indicating results of accelerated tests for electrostatic discharge damage of GMR elements in magnetic recording apparatuses manufactured using chassis having upper surfaces of various areas.

### DETAILED DESCRIPTION OF THE INVENTION

In the magnetic recording apparatus according to an embodiment of the present invention, metal portions and dielectric portions are made to pass alternately with facing to the read head within a distance of 50 nm or less, thereby discharging charges on the head. The dielectric portions accumulate charges created by, for example, friction with air and those created by the apparatus for some reason. On the other hand, the metal portions accumulate no charges. Therefore, when the metal portions and dielectric portions are passed alternately with facing to the head, an alternating electrical field is created, thereby making it possible to discharge (AC discharge) the charges accumulated in the GMR element of the read head located at a distance within 50 nm or less. Thus, the requirements for the discharge mechanism are: [1] the distance from the read head is within 50 nm or less; and [2] the metal portions and the dielectric portions are alternately passed with facing to the read head.

As a means for applying an AC electric field, an ordinary antenna that generates electric waves may be conceivable. However, the electric field from an antenna propagates a long distance and affects many devices other than the head. Further, an antenna may deposit charges depending on the configuration of the mechanical parts of the magnetic recording apparatus. In addition, it is not possible to spot a high intensity electric field from an antenna to a read head. By contrast, in the case where metal portions and dielectric portions are alternately passed with facing to the read head, it is possible to apply an alternating electric field sufficient to cause discharge within a close distance of 50 nm or less, although it is impossible to generate an electric field that propagates a long distance. In this manner, the charges accumulated on the GMR element can be discharged without affecting the other parts in the magnetic recording apparatus.

In the embodiment of the present invention, the dielectric constant of the dielectric portions should be 1 or more, and therefore it may be air. It is preferable that the dielectric constant of the parts should be 3 or more since the discharge capability is higher as the dielectric constant is higher. Further, as a protective layer, a material having a high sliding performance such as carbon may be deposited on the surfaces of the dielectric portions and metal portions at a thickness of 5 nm or less. Although carbon has conductivity, a thinner carbon film cannot discharge all the charges on the dielectric portions. The frequency of the alternating electric field, that is, the frequency of passing of the metal portions and dielectric portions should preferably be 1 MHz or higher to provide a high discharge effect. The size of each of the dielectric portions may be such as that a frequency of 1 MHz or more can be achieved at a practical linear velocity (rotational speed). More specifically, the lateral size of each of the dielectric portions should preferably be 200 nm or less, and more preferably 100 nm or less. In order to enhance the discharge efficiency, the distance between the GMR element and the discharge mechanism should preferably be 30 nm or less, and more preferably 20 nm or less.

When installing the discharge mechanism in the limited space in a chassis, it is preferable that the discharge mechanism should be formed on the magnetic disk that rotates at a distant of about 20 nm from the GMR element. In this case, the discharge mechanism has such a configuration that the metal portions and dielectric portions are formed alternately in the circumferential direction of the magnetic disk. The discharge mechanism may be formed to occupy only a part of the disk in the radial direction, or may be formed substantially entire surface of the disk.

In order to prevent the charging of the GMR element in the read head, it is preferable that an appropriate chassis should be devised. In ordinary magnetic recording apparatus, a flat box-shaped chassis is employed, and the largest surfaces of the chassis are, in many cases, made of a metal. With this structure, the magnetic recording apparatus itself is equivalent to a capacitor comprising two metal plates facing each other. Practically, the upper surface and the lower surface of the chassis are electrically connected to each other via some sort of electric circuit, and therefore they are not likely to have such a high electrostatic capacity. However, beneath the upper surface (cover member), a disk substrate, a printed circuit board and other components, which are dielectric, are randomly placed. As a result, a slight amount of charges may be sustained locally on the upper surface, which are equivalent to rows of capacitors connected in parallel. Since the charges are sustained on the metal surface, it appears to cause no problem in terms of the whole charge on the upper surface. However, even in a very small amount, if the sustained charges are injected to the GMR element in the read head for some reason, the GMR element comprises thin films of several nanometers may be easily broken. Therefore, in order to reduce the total amount of charges sustained on the apparatus, it is necessary to reduce the area of the largest surface of the chassis. Thus, with use of a chassis having a small surface area, it is possible to control the local charge in the chassis to a low level by means of the conductivity of the metal surface. In the embodiment of the present invention, the area of the largest surface of the chassis should preferably be 2,000 mm² or less, more preferably 1,000 mm² or less.

It is possible to reduce the total electric capacity by making a distance between two surfaces with the largest area in the chassis large. However, since many kinds of substances can be placed in the body space, the variation in the local electrostatic capacity caused by the internal components may be large. For this reason, the distance between the two surfaces of the chassis should preferably be set as short as possible. More specifically, the distance between the two surfaces of the chassis should preferably be set to 6 mm or less, more preferably 5 mm or less.

In order to effectively discharge the GMR element in the read head, it is preferable that a current should not be supplied to the GMR element when the magnetic head is loaded over the magnetic disk on which metal portions and dielectric portions are alternately formed. When the magnetic recording apparatus is reserved or transferred without connecting to the power line, charges may be highly accumulated. In order to discharge such charges, it is preferable that the apparatus should be first discharged with use of the discharge mechanism without supplying a current to the GMR element, and then a current is supplied to the GKR element.

### EXAMPLES

Examples of the present invention will now be described with reference to accompanying drawings.

### Example 1

With reference to FIG. 1, a magnetic recording apparatus according to an embodiment of the present invention will be described. The recording apparatus comprises, inside a chassis 10, a magnetic disk 11, a head slider 16 including a read head using a giant magnetoresistive element (GMR element), a head suspension assembly (a suspension 15 and an actuator arm 14) that supports the head slider 16, a voice coil motor (VCM) 17 and a circuit board.

The magnetic disk 11 is mounted on and rotated by a spindle motor 12. Various digital data are recorded on the magnetic disk 71 in perpendicular magnetic recording manner. The magnetic head incorporated in the head slider 16 is a so-called integrated head including a read head using a GMR element and a write head of a single pole structure. The suspension 15 is held at one end of the actuator arm 14 to support the head slider 16 so as to face the recording surface of the magnetic disk 11. The actuator arm 14 is attached to a pivot 13. The voice coil motor (VCM) 17, which serves as an actuator, is provided at the other end of the actuator 14. The voice coil motor (VCM) 17 drives the head suspension assembly to position the magnetic head at an arbitrary radial position of the magnetic disk 11. The circuit board comprises a head IC to generate driving signals for the voice coil motor (VCM) and control signals for controlling read and write operations performed by the magnetic head.

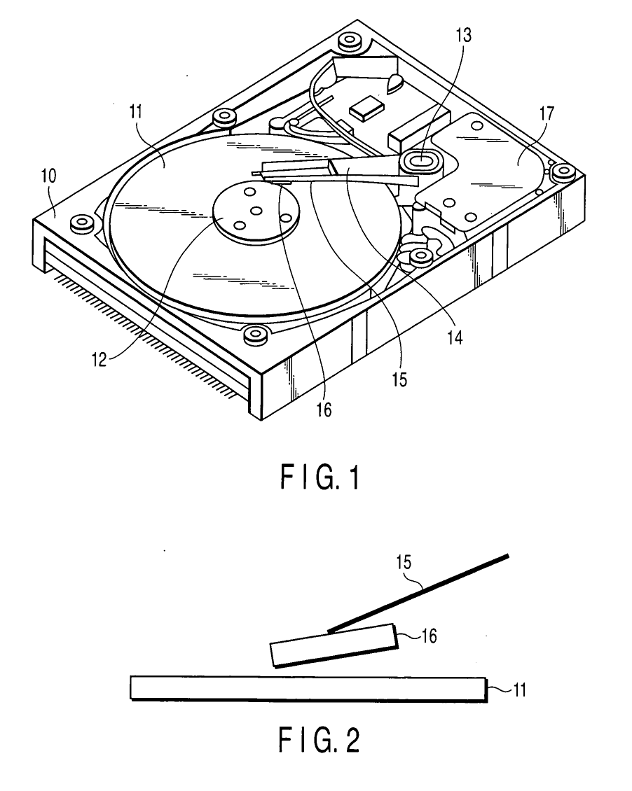

FIG. 2 is a diagram schematically showing a placement of the magnetic disk 11 and the head slider 16. The head slider 16 moves from the left-hand side to the right hand side relative to the magnetic disk 11. The read head and write head are formed on the terminal end (the portion closest to the magnetic disk 11) of the head slider 16. The head slider 16 is supported by the suspension 15, in which the distance between the head slider 16 and magnetic disk 11 is determined based on the balance between the force of the spring of the suspension 15 and the levitation force generated by the head slider 16.

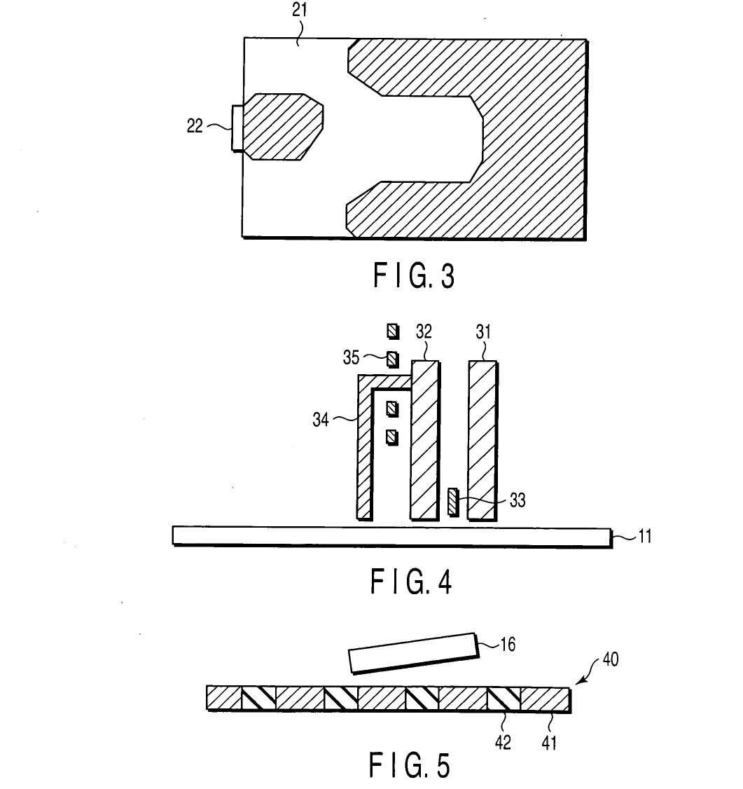

FIG. 3 shows the air-bearing surface 21 of the head slider 16. The air bearing surface (ABS) 21 has such a structure that the hatched sections thereof are protruded to the front side with respect to the surface of the paper sheet. This structure generates appropriate levitation force. A magnetic head 22 is formed on the trailing end of the head slider. The magnetic head 22 includes a read head using the GMR element and a write head of a single-pole structure. It should be noted that the structure shown in FIG. 3 is merely an example that satisfies a certain specification, and that the ABS can be modified in any configuration as long as a read head using a GMR element is provided.

FIG. 4 shows an example of the magnetic head 22. A GMR element 33 is sandwiched between a pair of shields 31 and 32. One of the shields, the shield 32, also serves as a return yoke, and a single pole head 34 is formed to be connected to the shield 32. A coil 35 is wound around the single pole head 34. It should be noted that the structure shown in FIG. 4 is merely an example, and the structure of the magnetic head 22 is not particularly limited.

FIG. 5 is a diagram schematically showing a placement of a discharge mechanism and the head slider. As shown in FIG. 5, a discharge mechanism 40 is formed into a flat shape, in which metal portions 41 and dielectric portions are alternately formed. The discharge mechanism 40 in the present Example has a disk form in which W as metal portions 41 and Al₂O₃ as dielectric portions 32 are alternately formed. The length of each metal portion is set to 200 nm, and that of each dielectric member is set to 200 nm, and the thickness thereof (the length in the perpendicular direction in FIG. 5) is set to 50 nm. Although it is not depicted in the figure, a carbon protective film having a thickness of about 5 nm and a lubricant are formed on the surface of the discharge mechanism 40. The discharge mechanism 40 is manufactured by the same method as in the case of forming a discharge mechanism on the surface of a magnetic disk, as will be described later.

The head slider 16 is supported over the discharge mechanism 40 at a flying height of several tens of nanometers. As the discharge mechanism 40 is rotated, the metal portions 41 and dielectric portions 42 of the discharge mechanism 40 pass alternately with facing to the read head formed on the trailing end of the head slider 16 at a distance within 50 nm or less, preferably 30 nm or less, and more preferably 20 nm or less.

A regular magnetic disk was mounted on the spindle to assemble a magnetic recording apparatus of the structure shown in FIG. 1, and then the apparatus was tested for flying characteristics of the magnetic head in various cases. Chassis used in these tests were of standard types for mounting 2.5-inch, 1.8-inch, 1-inch and 0.85-inch disks. The GMR elements used here were four types, CIP-GMR, CPP-GMR, TMR and CCP-GMR. Two sets of the four types of chassis and four types of heads were used in combinations, and a total of 32 apparatuses were prepared.

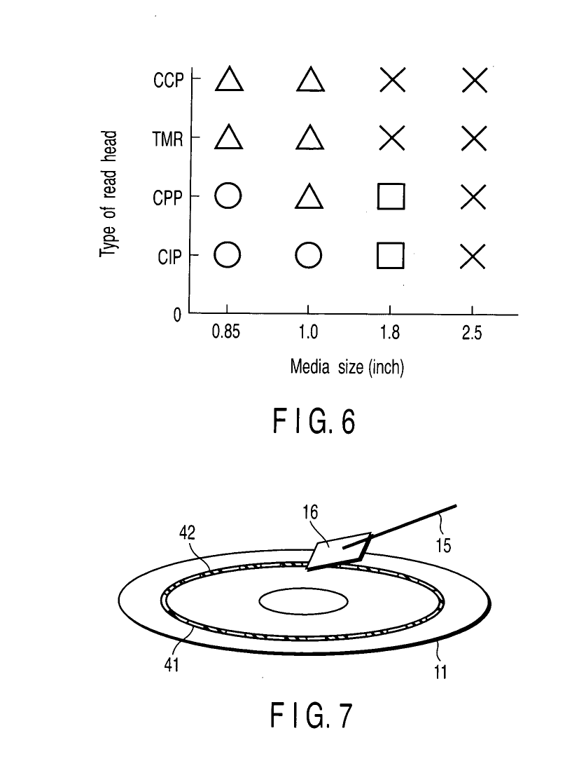

Each of the above samples was subjected to an accelerated degradation test, in which each sample was let stand for at least one week in a room where the humidity was maintained at 5%, and then the chassis was rubbed with woolen yarn for five minutes to generate static electricity. After that, the magnetic head was loaded, and the resistance was measured at both ends of the GMR element. Based on the measurements, the yield of the damage caused to the element was examined. The rubbing test with wool yarn was carried out 10 times for each sample, and the occurrence of the electrostatic discharge damage of the GMR element was determined. The results were summarized in FIG. 6.

As can be seen from FIG. 6, in the magnetic recording apparatus in which regular magnetic disks are installed, it was observed that electrostatic discharge damage occurred at least one time in all of the 16 types of apparatuses. In this figure, the circle plot denotes a case where the number of occurrence of electrostatic discharge damage is two or less, a triangle plot denotes that the number of occurrence of electrostatic discharge damage is five or less, a square plot denotes that the number of occurrence of electrostatic discharge damage is 10 or less, and a cross plot denotes that the number of occurrence of electrostatic discharge damage is 11 or more. The results indicate that as the size of the media increases, it is more easily damaged by static discharge. Further, it has been found that the CCP-GMR and TMR are more easily damaged by electrostatic discharge than the rest.

Next, the same tests were carried out using the discharge mechanism 40 in place of the magnetic disk. In these tests, no electrostatic discharge damage occurred in any of the 16 types of apparatuses. It can be concluded that the discharge mechanism according to the present invention has an effect of preventing the electrostatic discharge damage of the GMR element.

### Example 2

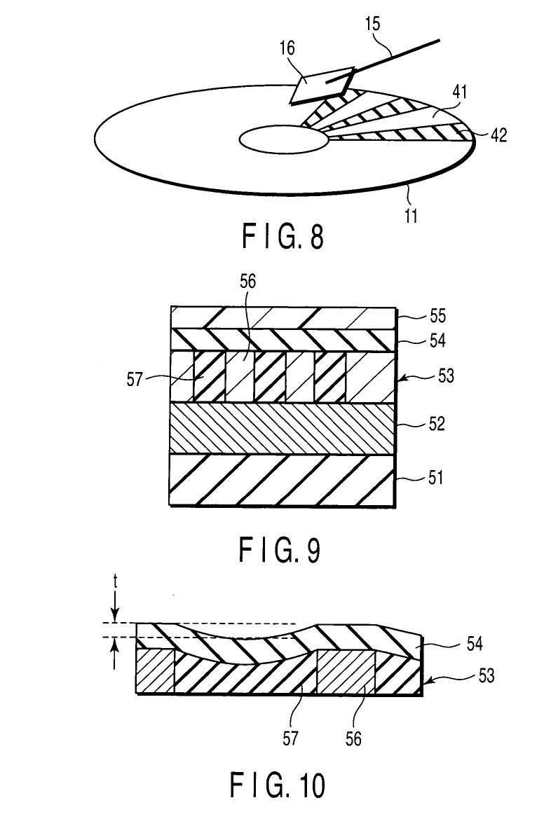

A sample magnetic recording apparatus was prepared using a magnetic disk provided with a discharge mechanism. As shown in FIG. 7, the discharge mechanism has such a structure that metal portions 41 and dielectric portions 42 are formed alternately and continuously in the circumferential direction of the magnetic disk 11. The discharge mechanism may be formed to occupy only a part thereof in the radial direction. Alternatively, as shown in FIG. 8, the discharge mechanism has such a structure that metal portions 41 and dielectric portions 42 are formed alternately in the circumferential direction of the magnetic disk 11, by which the discharge mechanism may be formed on substantially entire surface of the disk. It is alternatively possible to utilize, as the discharge mechanism, servo zones that include magnetic patterns used as servo signals and dielectric portions separating the magnetic patterns.

FIG. 9 is a cross-sectional view of a magnetic disk provided with a discharge mechanism according to the present Example. The magnetic disk shown in FIG. 9 has such a structure that, on a disk substrate 51, a soft underlayer (SUL) 52, a recording layer 53 and a protective layer 54 are deposited, and a lubrication layer 55 is applied to the protective layer 54. The magnetic disk according to the present Example has a structure that the magnetic patterns 56 are separated by the dielectric portions 57 formed such as to fill the recesses between the magnetic patterns. In the present Example, the disk substrate 51 is made of glass having a size of 0.85 inches.

For the magnetic disk of the present Example, materials and stacked structure of various layers used for ordinary perpendicular magnetic recording media can be applied. Materials used for the layers of the magnetic recording media as well as the stacked structure of the layers will be described below.

<Substrate>

The substrate may be, for example, a glass substrate, an Al alloy substrate, a ceramic substrate, a carbon substrate, a compound semiconductor substrate, or an Si single-crystal substrate. These substrates may be coated with a NiP layer. The glass substrate may be formed of amorphous glass or crystallized glass. The amorphous glass includes soda lime glass, aluminocilicate glass, or the like. The crystallized glass includes lithium-based crystallized glass or the like. The ceramic substrate includes a sintered body mainly formed of aluminum oxide, aluminum nitride, silicon nitride, or the like, or a material obtained by fiber-reinforcing the sintered body. In order to coat the surface of the substrate with a NiP layer, plating or sputtering is used.

<Soft Underlayer>

The magnetic recording media shown in FIG. 9 is a so-called perpendicular double layer media in which a perpendicular magnetic recording layer formed on a soft underlayer. The soft underlayer in the perpendicular double layer media is provided so as to pass a recording magnetic field from a recording magnetic pole through this layer and to return the recording magnetic field to a return yoke arranged near the recording magnetic pole. That is, the soft underlayer provides a part of the function of the write head, serving to apply a steep perpendicular magnetic field distribution to the recording layer so as to improve recording performance.

The soft underlayer is made of a high permeability material containing at least one of Fe, Ni, and Co. Such materials include, an FeCo alloy such as FeCo and FeCoV, an FeNi alloy such as FeNi, FeNiMo, FeNiCr and FeNiSi, an FeAl— and FeSi alloy such as FeAl, FeAlSi, FeAlSiCr, FeAlSiTiRu and FeAlO, an FeTa alloy such as FeTa, FeTaC and FeTaN, and an FeZr alloy such as FeZrN.

The soft underlayer may be made of a material having a microcrystalline structure or a granular structure containing fine grains dispersed in a matrix such as FeAlO, FeMgO, FeTaN, and FeZrN, each containing 60 at % or more of Fe.

The soft underlayer may be made of other materials such as a Co alloy containing Co and at least one of Zr, Hf, Nb, Ta, Ti and Y. The material preferably contains 80 at % or more of Co. An amorphous layer is easily formed when such a Co alloy is deposited by sputtering. The amorphous soft-magnetic material exhibits very excellent soft magnetism because of free of magnetocrystalline anisotropy, crystal defects and grain boundaries. Further, the use of the amorphous soft-magnetic material reduces noise from the media. Preferred amorphous soft-magnetic materials include, for example, a CoZr—, CoZrNb— and CoZrTa-based alloys.

Another underlayer may be provided under the soft underlayer in order to improve the crystalinity of the soft underlayer or the adhesion to the substrate. Materials for the underlayer include Ti, Ta, W, Cr, Pt, and an alloy thereof, and oxide and nitride containing the above metal.

An intermediate layer consisting of a nonmagnetic substance may be provided between the soft underlayer and the perpendicular magnetic recording layer. The intermediate layer serves to suppress exchange coupling interaction between the soft underlayer and the recording layer and to control the crystalinity of the recording layer. Materials for the intermediate layer include Ru, Pt, Pd, W, Ti, Ta, Cr, Si and an alloy thereof, and oxide and nitride containing the above metal.

To prevent spike noise, the soft underlayer may be divided into layers that are antiferromagnetically coupled with each other through a Ru layer with a thickness of 0.5 to 1.5 nm sandwiched therebetween. Alternatively, the soft-magnetic layer may be exchange-coupled with a pinning layer made of a hard magnetic material with in-plane anisotropy, such as CoCrPt, SmCo and FePt, or an antiferromagnetic material such as IrMn and PtMn. In this case, to control the exchange coupling force, a magnetic layer such as Co or a nonmagnetic layer such as Pt may be stacked on and under the Ru layer.

<Perpendicular Magnetic Recording Layer>

The perpendicular magnetic recording layer is made of, for example, a material mainly containing Co, containing at least Pt, containing Cr as required, and further containing an oxide (such as silicon oxide and titanium oxide). In the perpendicular magnetic recording layer, magnetic crystal grains preferably form a columnar structure. In a perpendicular magnetic recording layer having such a structure, the magnetic crystal grains have favorable orientation and crystality, making it possible to provide a signal-to-noise ratio (SNR) suitable for high-density recording. The amount of oxide is important for obtaining the above structure. The content of the oxide in the total amount of Co, Pt and Cr is preferably 3 mol % or more and 12 mol % or less, more preferably 5 mol % or more and 10 mol % or less. If the oxide content of the perpendicular magnetic recording layer is within the above range, the oxide is precipitated around the magnetic grains, making it possible to isolate the magnetic grains and to reduce their sizes. If the oxide content exceeds the above range, the oxide remains in the magnetic grains to degrade the orientation and crystalinity. Moreover, the oxide is precipitated over and under the magnetic grains to prevent formation of the columnar structure. On the other hand, if the oxide content is less than the above range, the isolation of the magnetic grains and the reduction in their sizes are insufficient. This increases media noise and making it impossible to obtain a signal-to-noise ratio (SNR) suitable for high-density recording.

The Pt content of the perpendicular magnetic recording layer is preferably 10 at % or more and 25 at % or less. When the Pt content is within the above range, the perpendicular magnetic recording layer provides a required uniaxial magnetic anisotropy constant Ku. Moreover, the magnetic grains exhibit good cyrstalinity and orientation, resulting in thermal fluctuation characteristics and read/write characteristics suitable for high-density recording. If the Pt content exceeds the above range, a layer of an fcc structure may be formed in the magnetic grains to degrade the crystalinity and orientation. On the other hand, if the Pt content is less than the above range, it is impossible to obtain a uniaxial magnetic anisotropy constant Ku and thus thermal fluctuation characteristics suitable for high-density recording.

The Cr content of the perpendicular magnetic recording layer is preferably 0 at % or more and 16 at % or less, more preferably 10 at % or more and 14 at % or less. When the Cr content is within this range, high magnetization can be maintained without reduction in uniaxial magnetic anisotropy constant Ku. This brings sufficient read/write characteristics and thermal fluctuation characteristics suitable for high-density recording. If the Cr content exceeds the above range, Ku of the magnetic grains decreases to degrade the thermal fluctuation characteristics and the crystalinity and orientation of the magnetic grains. As a result, the read/write characteristics may be degraded.

The perpendicular magnetic recording layer may contain not only Co, Pt, Cr and an oxide but also one or more additive elements selected from the group consisting of B, Ta, Mo, Cu, Nd, W, Nb, Sm, Tb, Ru and Re. These additive elements enable to facilitate reduction in the sizes of the magnetic grains or to improve the crystalinity and orientation. This in turn makes it possible to provide read/write characteristics and thermal fluctuation characteristics more suitable for high-density recording. The total content of these additive elements is preferably 8 at % or less. If the total content exceeds 8 at %, a phase other than an hcp phase is formed in the magnetic grains. This degrades crystalinity and orientation of the magnetic grains, making it impossible to provide read/write characteristics and thermal fluctuation characteristics suitable for high-density recording.

Other materials for the perpendicular magnetic recording layer include a CoPt alloy, a CoCr alloy, a CoPtCr alloy, CoPtO, CoPtCrO, CoPtSi and CoPtCrSi. The perpendicular magnetic recording layer may be formed of a multilayer film containing a film of an alloy mainly including an element selected from the group consisting of Pt, Pd, Rh and Ru and a Co layer. The perpendicular magnetic recording layer may be formed of a multilayer film such as CoCr/PtCr, CoB/PdB and CoO/RhO, which are prepared by adding Cr, B or O to each layer of the above multilayer film.

The thickness of the perpendicular magnetic recording layer preferably ranges between 5 nm and 60 nm, more preferably between 10 nm and 40 nm. A perpendicular magnetic recording layer having a thickness within the above range is suitable for high-density recording. If the thickness of the perpendicular magnetic recording layer is less than 5 nm, read output tends to be so low that a noise component becomes relatively high. On the other hand, when the thickness of the perpendicular magnetic recording layer exceeds 40 nm, read output tends to be so high as to distort waveforms. The coercivity of the perpendicular magnetic recording layer is preferably 237,000 A/m (3,000 Oe) or more. If the coercivity is less than 237,000 A/m (3,000 Oe), the thermal fluctuation tolerance may be degraded. The perpendicular squareness of the perpendicular magnetic recording layer is preferably 0.8 or more. If the perpendicular squareness is less than 0.8, the thermal fluctuation tolerance tends to be degraded.

<Protective Layer>

The protective layer serves to prevent corrosion of the perpendicular magnetic recording layer and to prevent damage to the media surface when the magnetic head comes into contact with the media. Materials for the protective layer include, for example, C, SiO₂ and ZrO₂. The protective layer preferably has a thickness of 1 to 10 nm. When the thickness of the protective layer is within the above range, the distance between the head and the media can be reduced. This is suitable for high-density recording.

<Lubrication Layer>

The lubricant may be made of, for example, perfluoropolyether, fluorinated alcohol or fluorinated carboxylic acid.

The following is an example of the method of manufacturing a magnetic disk.

<Manufacture of Stamper>

First, a master plate used as an original of the pattern was prepared in the following manner. A Si substrate was coated with a photosensitive resin, and then the photosensitive resin was irradiated with an electron beam to form a latent image. The latent image was developed to form protruded and recessed patterns. The patterns were formed with use of an electron beam lithography apparatus comprising a signal source that irradiates the photosensitive resin on the substrate with the electron beam at a predetermined timing, and a stage that moves the substrate at high accuracy synchronously with the signal source.

Then, a Ni conductive film was deposited on the prepared resist master by an ordinary sputtering method. Then, a nickel electroplated film having a thickness of about 300 μm was formed on the conductive film by electroplating. In the electroplating, high-concentration nickel sulfamate plating liquid (NS-160), available from Showa Chemical Industry Co., Ltd., was used. The electroplating conditions were as follows:
Nickel sulfamate: 600 g/L,
Boric acid: 40 g/L,
Surfactant (sodium lauryl sulfate): 0.15 g/L,
Liquid temperature: 55° C.,
pH: 3.8 to 4.0, and
Current Density: 20 A/dm².

After that, the electroplated film was stripped from the resist master and thus a stamper that includes the conductive film, electroplated film and resist residue was obtained. Then, the resist residue was removed by oxygen plasma ashing. In the present Example, the oxygen plasma ashing was carried out at 100 W for 10 minutes in a chamber to which oxygen gas was introduced at 100 ml/min to adjust the internal pressure to 4 Pa.

The resultant father stamper itself can be used as an imprinting stamper. However, the aforementioned electroplating process was carried out on the father stamper repeatedly to replicate a great number of stampers in the following manner. First, an oxygen plasma ashing similar to the step of removing the resist residue was carried out and thus an oxide passivation film was formed on the surface of the father stamper. At this time, the father stamper was processed under 300 W for 3 minutes, in a chamber to which oxygen gas was introduced at 100 ml/min to adjust the interior pressure to 4 Pa. After that, a nickel electroplated film was formed in the same manner as described above by electroplating. Then, the electroplated film was stripped from the father stamper, and thus a mother stamper, which is a reversed form of the father stamper, was obtained. By repeating the processes for forming the mother stamper from the father stamper, 10 or more mother stampers having the same form were obtained.

After that, in a similar manner to those procedures of obtaining a mother stamper from the father stamper, an oxide passivation film was formed on the surface of a mother stamper, an electroplated film was formed on the mother stamper, and then the electroplated film was stripped to obtain a son stamper, which had the same protruded and recessed patterns as those of the father stamper.

<Imprinting>

The (son) stamper was subjected to ultrasonic cleaning with acetone for 5 minutes. Then, the stamper was immersed in a solution prepared by diluting a chlorine-based fluorocarbon resin-containing silane coupling agent, that is fluoroalkylsilane [CF₃(CF₂)₇CH₂CH₂Si(Ome)₃] (TSL8233 manufactured by GE Toshiba Silicones), which was used as a fluorine-based releasing agent, with ethanol to 2%. Then, the solution was blown with a blower and the stamper was annealed in a nitrogen atmosphere at 120° C. for one hour. On the other hand, a magnetic disk was coated with a resist, which was prepared by diluting S1818 (tradename of Rohm and Haas Electronic Materials) five times with propyleneglycol monomethyl ether acetate (PGMEA), or S1801, by use of a spin coater. Then, the stamper having protruded and recessed patterns formed thereon are pressed onto the resist on the magnetic disk at 450 bar for 60 seconds to transfer the patterns to the resist. After that, the stamper was removed using a vacuum tweezers. After the transfer of the patterns onto the resist, the resist was cured by UV irradiation for 5 minutes to retain the surface configuration of the protruded and recessed patterns. Then, the entire resist film was crosslinked by heating at 160 for 30 minutes.

<Media Etching>

In order to remove the resist residue in the recessed portions on the magnetic disk, the disk was subjected to RIE using oxygen gas. Subsequently, the magnetic disk was etched by Ar ion milling. In order to avoid damages on the ferromagnetic recording layer, which can be achieved by suppressing re-deposition, the etching was carried out by varying the ion incident angle to 30° and 70°. After the etching of the magnetic film, an oxygen RIE was carried out to strip the etching mask. After processing the magnetic film, the carbon protective film was formed. The resultant media was coated with a lubricant by dipping.

With the aforementioned processes, a magnetic disk having a surface configuration of protruded and recessed patterns can be manufactured. In this case, the metal portions are made of a magnetic material such as CoCrPt, and the dielectric portions are a composite of air, the carbon protective layer and the lubricant. As schematically shown in FIG. 7, the discharge mechanism has such a pattern that the metal portions 41 and the dielectric portions 42 are alternately arranged on one track.

Alternatively, it is possible to manufacture a magnetic disk having a substantially flat surface. A method of manufacturing such a magnetic disk will be described below.

The processes of manufacturing the stamper are the same as those described above. In the imprinting process, the magnetic disk was coated with SOG (spin-on-glass) by use of a spin coater. SOGs can be categorized, in accordance with the chemical structure of siloxane, to silica glass, alkylsiloxane polymer, alkylsilsesquioxane polymer (MSQ), hydrogenated silsesquioxane polymer (HSQ), hydrogenated alkylsiloxane polymer (HOSP), etc. In this alternative method, the material obtained by diluting T-7 of Tokyo Ohka Kogyo Co., Ltd. and FOX of Dow Corning Corporation with methylisobutylketone (MIBK) five times was used. After the application of the SOG, the disk was placed in an oven and prebaked at 100° C. for 20 minutes, to evaporate the solvent within the SOG, thereby maintaining the SOG at an appropriate hardness. After that, the stamper in which patterns of recording tracks and serve data are embedded was pressed onto the SOG resist at 450 bar for 60 seconds, thereby transferring the patterns onto the SOG resist.

Next, in the etching process, the residue of the SOG film in the recessed portions was removed using an ICP (inductively coupled plasma) etching apparatus. As the etching gas, SF₆ was used. The chamber pressure was set to 2 mTorr. For the ICP, coil RF and platen RF were set to 100 W, respectively. The etching time was 2 minutes and 40 seconds. The milling process for the magnetic disk was similar to that described above.

After the milling, the recessed portions were filled with the same SOG as that used for the resist using the spin coater. After that, the SOG was etched back until the magnetic film was exposed by milling. In this case, the dielectric portions 57 are made of SiO₂. Alternatively, for the filling process, it is possible that Al₂O₃, Ta₂O₅ or the like is deposited by an ordinary sputtering method and then the film is etched back by milling. In this case, an arbitrary material that can be sputtered is used as the material for the dielectric portions.

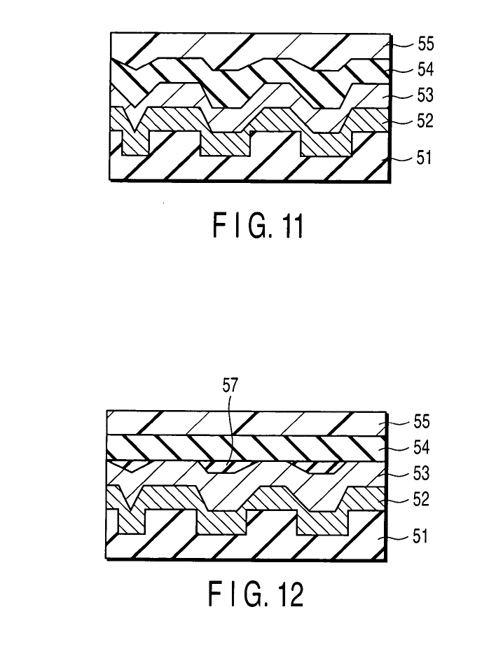

It should be noted that if the amount of etch-back is increased, it is possible to manufacture such a magnetic disk as shown in FIG. 10, in which the dielectric portions are embedded in the recessed portions on the surface and the surface also has protrusions and recesses. Further, it is possible to manufacture such a magnetic disk as shown in FIG. 11, in which with a similar method to that described above, protrusions and recesses are formed on the disk substrate 51 and then the media films are formed by the method of manufacturing an ordinary magnetic disk. Furthermore, by combination of the embedding and the etch-back of the dielectric material described above, it is possible to manufacture such a substantially flat magnetic disk as shown in FIG. 12, with use of the substrate 51 having protrusions and recesses.

Magnetic disks manufactured in the present Example were subjected to an accelerated test for electrostatic discharge damage similar to that used in Example 1. The results indicated that no electrostatic discharge damage occurred. Further, for the 0.85-inch type apparatus, magnetic disks having the structures shown in FIGS. 10, 11 and 12 were manufactured and then they were subjected to the similar electrostatic discharge damage test. In each of these magnetic disks, the servo zones including the metal portions and dielectric portions were used as the discharge mechanism. In each case, the servo zones extended over the entire surface in the radial direction and had a circumferential length of about 100 nm. The servo zones appeared 128 times along the circumference of the disk, and the rest is used as data zones in which recording tracks are formed to record data. With this structure, both functions of a discharge mechanism and magnetic recording can be performed simultaneously. According to the results of the accelerated tests, no electrostatic discharge damage occurred. The results indicates that with the present invention, the effect of preventing electrostatic discharge damage can be obtained simply by providing metal portions and dielectric portions on a magnetic disk regardless of the method of manufacturing the magnetic disk.

### Example 3

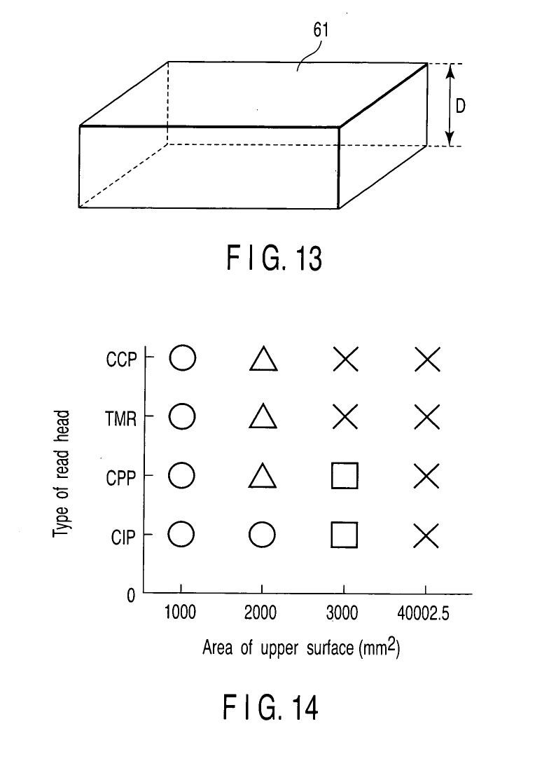

A magnetic recording apparatus similar to that of Example 2 was manufactured. A 0.85-inch or 1.0-inch magnetic disk was used. As shown in FIG. 13, the area of an upper surface 61, which is the largest surface of the chassis, was changed in a range of 1000 to 4000 mm². The distance D between the upper surface and lower surface was set to 6 mm. In the case of the 0.85-inch media, the area of the upper surface was changed to 1000, 2000 and 3000 mm². In the case of the 1.0-inch media, the area of the upper surface was changed to 2000, 3000 and 4000 mm². The number of apparatus was 10 for each set, that is, 10 apparatuses for each of the types of 1000 and 4000 mm² and 20 apparatuses for each of the types of 2000 and 3000 mm².

In the present Example, the accelerated tests were carried out under more severe conditions than those of Example 2 in the following manner. That is, the magnetic recording apparatus was connected to a personal computer (PC) and read/write operations were carried out for 10 minutes. Next, the apparatus was disconnected from the computer and let stand in a room in which the humidity was maintained at 5% for 1 week or more. After that, the chassis was placed in a wool pocket and was shaken 500 times while being disconnected. Then, the apparatus was connected to the PC. Further, before loading the head over the media, A current was supplied to the head. The results of the tests were summarized in FIG. 14. In this figure, a circle plot denotes that the electrostatic discharge damage did not occur, a triangle plot denotes that the ratio of the apparatus in which electrostatic discharge damage occurred was 10% or less, a square plot denotes that the ratio of the apparatus in which electrostatic discharge damage occurred was 50% or less, and a cross plot denotes the rest. As can be understood from this figure, when the area of the upper surface is 2000 mm² or less, the effect of preventing the electrostatic discharge damage is more prominent. Since these tests were carried out under accelerated conditions, if an apparatus has the electrostatic discharge damage yield in the test of 10% or less, the apparatus is considered to have no problem as a product. In the case where a TMR element or CCP-GMR element is used, which can perform further higher-density magnetic recording, it is safe to use a chassis with a largest surface of 1000 mm² or less.

A drive in which a distance between surfaces was set to 8 mm was manufactured, and the same tests were carried out. The results indicated that even for the size of 1000 mm², the electrostatic discharge damage yield was 50% or less. Further, for the apparatus of a largest surface of 1000 mm², the distance between surfaces was set to 5 mm, and the same tests were carried out. The results indicated that the yield was 0 for both cases of the TMR element and CCP-GMR element.

### Example 4

The magnetic recording apparatuses with chassis whose areas of the upper surfaces are 2000 mm² and 3000 mm², which were manufactured in connection with Example 3 were subjected to similar tests to those described above, without supplying a current to the head before loading over the magnetic disk. The results indicated that no electrostatic discharge damage occurred in the TMR element or CCP-GMR element even in the case where the area of the upper surface was 2000 mm². Therefore, it has been found that it is better for preventing the electrostatic damage of the read element not to supply a current to the head before loading over the media when apparatuses are required to be operated in severe environments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A magnetic recording apparatus comprising:
a magnetic recording media;
a spindle motor which rotates the magnetic recording media;
a flying head slider including a read head using a giant magnetoresistive element;
an actuator which moves the head slider over the magnetic recording media;
a chassis which houses the above members; and
a discharge mechanism which permits to pass metal portions and dielectric portions alternately with facing to the read head within a distance of 50 nm or less.

2. The magnetic recording apparatus according to claim 1, wherein the magnetic recording media comprises the discharge mechanism of a structure in which the metal portions and dielectric portions are alternately placed in a circumferential direction of the media.

3. The magnetic recording apparatus according to claim 2, wherein the discharge mechanism is formed in a part of the magnetic recording media.

4. The magnetic recording apparatus according to claim 2, wherein the discharge mechanism is formed substantially whole surface of the magnetic recording media in the radial direction.

5. The magnetic recording apparatus according to claim 1, wherein the magnetic recording media uses, as the discharge mechanism, servo zones of a structure in which the metal portions and dielectric portions are alternately placed in a circumferential direction of the media.

6. The magnetic recording apparatus according to claim 1, wherein each of the dielectric portions has a length of 200 nm or less in a moving direction thereof.

7. The magnetic recording apparatus according to claim 6, wherein each of the dielectric portions has a length 100 nm or less in the moving direction thereof.

8. The magnetic recording apparatus according to claim 1, wherein the dielectric portions have a dielectric constant of 1 or more.

9. The magnetic recording apparatus according to claim 8, wherein the dielectric portions have a dielectric constant of 3 or more.

10. The magnetic recording apparatus according to claim 1, wherein a distance between the read head and the discharge mechanism is 30 nm or less.

11. The magnetic recording apparatus according to claim 10, wherein the distance between the read head and the discharge mechanism is 20 nm or less.

12. The magnetic recording apparatus according to claim 1, wherein two surfaces of the chassis having a largest area are made of a material mainly made of a metal, and wherein the area of each of these surfaces is 2000 mm² or less, and a distance between the two surfaces is 6 mm or less.

13. The magnetic recording apparatus according to claim 12, wherein the area of each of the two largest surfaces of the chassis is 1000 mm² or less.

14. The magnetic recording apparatus according to claim 12, wherein the distance between the two largest surfaces of the chassis is 5 mm or less.

15. The magnetic recording apparatus according to claim 1, wherein the read head is not supplied a current when the flying head slider is loaded over the magnetic recording media.
